(19) United States
(12) Patent Application Publication
(10) Pub. No.: US 2020/0210201 A1
(43) Pub. Date: Jul. 2, 2020

(54) INFORMATION PROCESSING SYSTEM AND RELAY DEVICE

(71) Applicant: FUJITSU CLIENT COMPUTING LIMITED, Kanagawa (JP)

(72) Inventors: Yuki Kawama, Kawasaki (JP); Masatoshi Kimura, Kawasaki (JP); Akira Takeuchi, Kawasaki (JP); Hiroki Teramoto, Kawasaki (JP)

(73) Assignee: FUJITSU CLIENT COMPUTING LIMITED, Kanagawa (JP)

(21) Appl. No.: 16/685,491

(22) Filed: Nov. 15, 2019

(30) Foreign Application Priority Data
Dec. 28, 2018 (JP) 2018-248664

(51) Int. Cl. G06F 9/4401; G06F 11/30; G06F 1/3215

(52) U.S. Cl. CPC G06F 9/442; G06F 1/3215; G06F 11/3062; G06F 9/4418

(57) ABSTRACT

An information processing system includes a plurality of information and a relay device. The information processing devices each includes a processor. The relay device connects the information processing devices via an expansion bus and relays communication between the information processing devices. The relay device includes a power supply controller that controls supply of power to the information processing devices, and performs control to shut off supply of power to the relay device and the information processing devices after detecting shutdown of all the information processing devices.

### CROSS-REFERENCE TO RELATED APPLICATIONS

This application is based upon and claims the benefit of priority from Japanese Patent Application No. 2018-248664, filed Dec. 28, 2018, the entire contents of which are incorporated herein by reference.

### TECHNICAL FIELD

The present disclosure relates generally to an information processing system and a relay device.

### BACKGROUND

There has been known a technique that performs parallel computation using a plurality of computers (arithmetic devices), and for example, there has been proposed an information processing system that exchanges data between the computers using an Ethernet (registered trademark) line.

In such a configuration, when different systems (for example, OSs) are installed in a plurality of computers, a configuration in which a computer serving as a host manages shutdown processing or performs communication between the computers to shift to the shutdown processing is employed as a method in which an information processing system performs shutdown.

However, in the case of employing the configuration in which the computer serving as a host manages the shutdown processing or the configuration in which the shutdown processing is performed by performing communication between the computers, when the computer serving as a host enters an abnormal state or is not able to perform communication at a software level (for example, an application level), there is the problem that it is not possible to start the shutdown processing.

### SUMMARY

According to an aspect of the present disclosure, an information processing system includes a plurality of information and a relay device. The plurality of information processing devices each includes a processor. The relay device is able to connect the plurality of information processing devices via an expansion bus and relays communication between the plurality of information processing devices. The relay device includes a power supply controller that controls supply of power to the plurality of information processing devices, and performs control to shut off supply of power to the relay device and the plurality of information processing devices after detecting shutdown of all the plurality of information processing devices.

### BRIEF DESCRIPTION OF THE DRAWINGS

FIG. 1 is a schematic configuration block diagram mainly illustrating a connection configuration of a power supply system in an information processing system of an embodiment;

FIG. 2 is an explanatory diagram of a software configuration example of a platform;

FIG. 3 is a diagram for explaining an example of a processing sequence flowchart at the time of start-up processing of a first embodiment;

FIG. 4 is a diagram for explaining an example of a processing sequence flowchart at the time of shutdown processing of a first embodiment;

FIG. 5 is a diagram for explaining an example of a processing sequence flowchart at the time of shutdown processing of a second embodiment;

FIG. 6 is a diagram for explaining an example of a processing sequence flowchart at the time of shutdown processing of a third embodiment; and

FIG. 7 is a diagram for explaining an example of a processing sequence flowchart at the time of shutdown processing of a fourth embodiment.

### DETAILED DESCRIPTION

Hereinafter, an embodiment according to the present relay device and the present information processing system will be described with reference to the drawings. However, the following embodiment is merely an example and there is no intention to exclude application of various modification examples and technologies not explicitly described in the embodiment. That is, the present embodiment can be implemented with various modifications without departing from the scope thereof. Furthermore, each drawing is not intended to include only components illustrated in the drawing and is able to include other functions and the like.

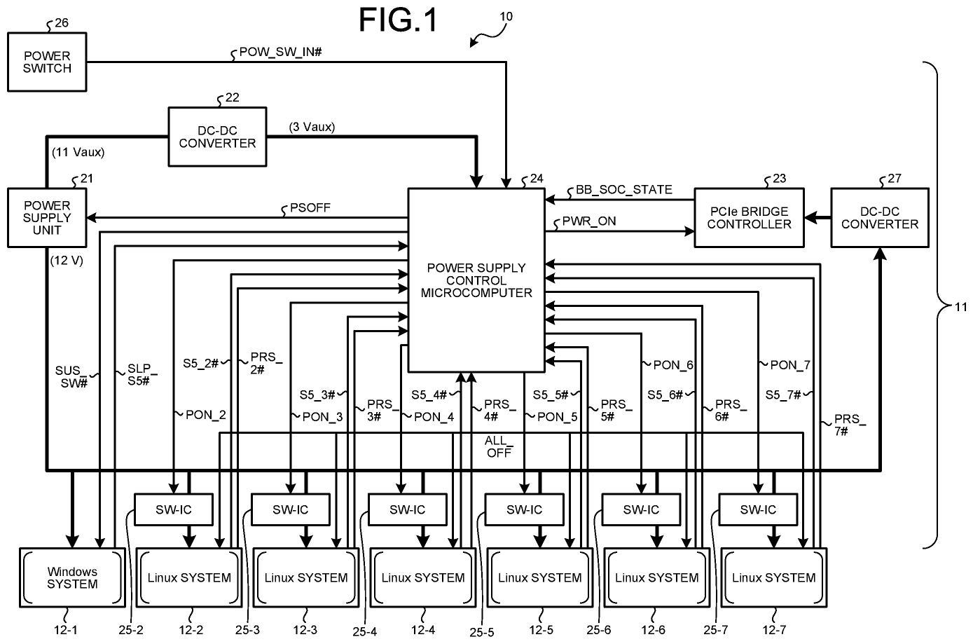

FIG. 1 is a schematic configuration block diagram mainly illustrating a connection configuration of a power supply system in an information processing system of an embodiment.

The following description will be given for a case where a PCI express (PCIe) [registered trademark] is used as an example of an expansion bus.

An information processing system 10 roughly includes a bridge board 11 and a plurality of platforms 12-1 to 12-6.

The bridge board 11 roughly includes a power supply unit 21, a DC-DC converter 22, a PCIe bridge controller 23, a power supply control microcomputer 24, switching ICs 25-2 to 25-7, a power switch 26, and a DC-DC converter 27.

The power supply unit 21 converts AC power supplied from a commercial power supply into DC power having a predetermined voltage (for example, 12 V) and supplies the DC power to each element.

The DC-DC converter 22 converts power (for example, 11 V that is supplied at all times) supplied from the power supply unit 21 into a power supply voltage (for example, 3 V) of the power supply control microcomputer 24, and supplies the power supply voltage.

The PCIe bridge controller 23 controls communication among the platforms 12-1 to 12-7.

The power supply control microcomputer 24 controls the supply of power to the PCIe bridge controller 23 and the supply of the power to the platforms 12-1 to 12-7 via the switching ICs 25-2 to 25-7 in response to an operation of the power switch 26.

The switching IC 25-2 to the switching IC 25-7 are placed under the control of the power supply control microcomputer, and supplies or shuts off the power to the platforms 12-2 to 12-7 to which the switching IC 25-2 to the switching IC 25-7 are connected.

The DC-DC converter 27 converts power (for example, 12 V that is supplied at the time of working) supplied from the power supply unit 21 into a power supply voltage to the PCIe bridge controller 23, and supplies the power supply voltage to the PCIe bridge controller 23.

Each of the platforms 12-1 to 12-7 is configured as a board-type computer (an information processing device) including a memory, such as a micro processing unit (MPU), a read only memory (ROM), and a random access (RAM), and various input/output interfaces (I/O interfaces).

The platform (host, root complex) 12-1 is installed with, for example, Windows as an OS, and manages and supervises the other platforms (devices, endpoints) 12-2 to 12-7. That is, the platform 12-1 serves as a host (or a root complex serving as a host).

The platforms 12-2 to 12-7 perform processing under the control of the platform 12-1 (that is, serving as a device or an endpoint serving as a device) independently or in cooperation with other platforms, and transmit processing results to a platform that performs processing of a next stage or the platform 12-1 as required or according to previous setting.

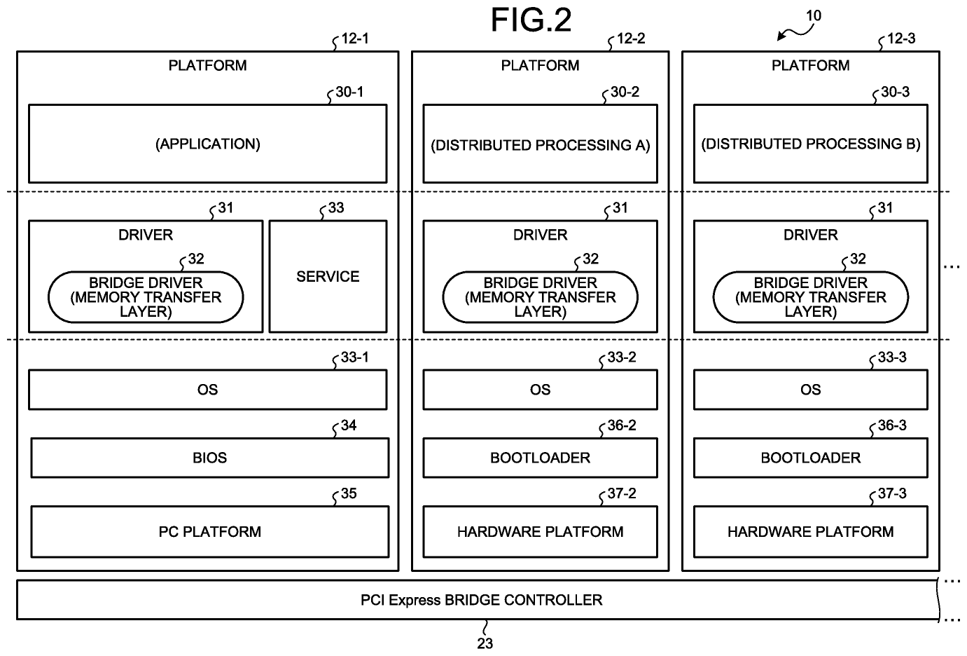

FIG. 2 is an explanatory diagram of a software configuration example of a platform.

MPUs provided in a platform 12-1 to a platform 12-7 may be provided by vendors different from one another.

The platform 12-1 performs various processes under the control of an application program 30-1.

A basic input output system (BIOS) 34 for starting up a bootloader is embedded in the platform 12-1. The bootloader detects and starts up an OS 33-1 (for example, Windows).

In this way, the OS 33-1 reads various drivers 31 including a bridge driver 32 for controlling a PCIe bridge controller 23, electrically accesses the PCIe bridge controller 23 via the bridge driver 32 and a PC platform 37-2, and communicates with the other platforms 12-2 to 12-7, thereby performing actual processing.

Next, the platforms 12-2 to 12-7 will be described.

Since the platforms 12-2 to 12-7 have the same configuration, the platform 12-2 will be described as an example.

The platform 12-2 performs various processes under the control of an application program 30-2.

A bootloader 36-2 is embedded in the platform 12-2, detects an OS 33-2 (for example, Linux; registered trademark) by the bootloader, and starts up the OS 33-2.

In this way, the OS 33-2 reads a bridge driver 32 for controlling the PCIe bridge controller 23, electrically accesses the PCIe bridge controller 23 via the bridge driver 32 and a hardware platform 37-2, and communicates with the other platforms 12-1, and 12-3 to 12-7, thereby performing actual processing.

Furthermore, in the aforementioned configuration, the platforms 12-1 to 12-7 are configured to be independently operable so as not to affect other driver configurations, respectively.

### [1] Operation of First Embodiment

Next, an operation of the first embodiment will be described.

First, processing at the time of start-up will be described.

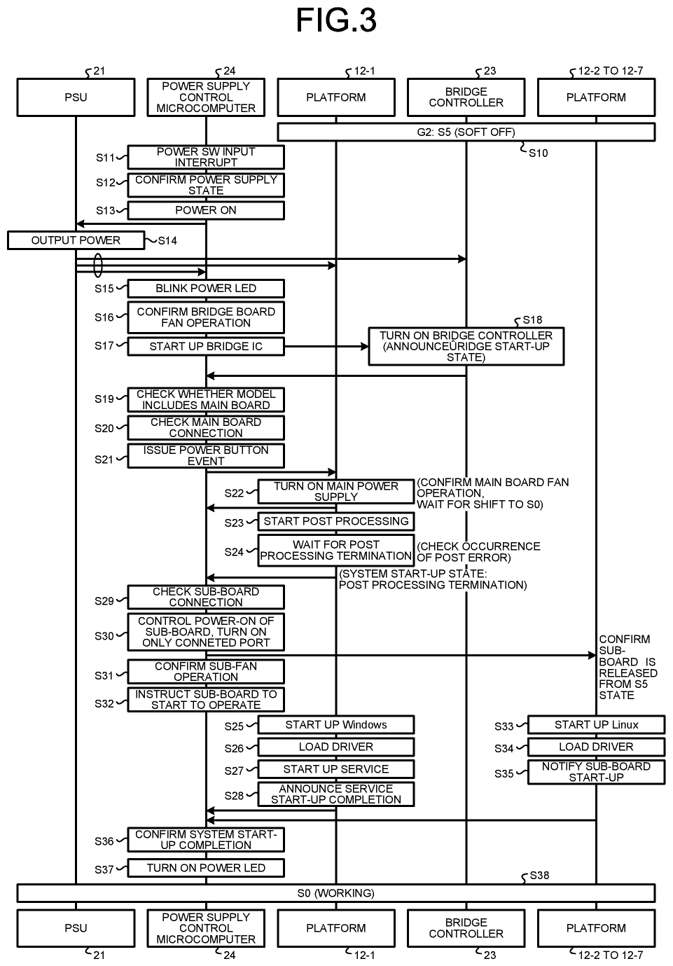

FIG. 3 is a diagram for explaining an example of a processing sequence flowchart at the time of start-up processing of the first embodiment.

In an initial state, it is assumed that the power supply unit 21 and the power supply control microcomputer 24 are in a standby state (low power consumption mode) and the platform 12-1, the PCIe bridge controller 23, and the platforms 12-2 to 12-7 are in a non-working state (Soft off) (S5 state) (step S10).

When the power switch is pressed in the standby state, the power supply control microcomputer 24 detects a power switch input interrupt (step S11) and confirms a power supply state (step S12).

Subsequently, the power supply control microcomputer 24 sends a power-on command for instructing the start of supply of predetermined power (for example, DC 12 V) to the power supply unit 21 (step S13).

In this way, the power supply unit 21 starts the supply of the predetermined power to the power supply control microcomputer 24, the platform 12-1, and the PCIe bridge controller 23 (step S14).

Accordingly, the power supply control microcomputer 24 causes a power LED (a power indicator, not illustrated) to be in a flickering state (step S15), and confirms whether a fan (bridge board fan) of the bridge board 11, which is a board on which the power supply control microcomputer 24 and the PCIe bridge controller 23 are installed, is operating normally (step S16).

When the fan of the bridge board is operating normally, the power supply control microcomputer 24 starts up the PCIe bridge controller 23 (step S17).

In this way, the PCIe bridge controller 23 shifts to an on state (operating state) and notifies the power supply control microcomputer 24 of a bridge start-up state (step S18).

In this way, the power supply control microcomputer 24 determines the presence or absence of a model in which the platform 12-1 (denoted as a main board in the drawing) exists (step S19).

In the case of the model in which the platform 12-1 exists, the power supply control microcomputer 24 checks the connection state of the platform 12-1 (step S20) and issues a power button event to the platform 12-1 (step S21).

In this way, the platform 12-1 shifts to a power-on state (step S22) and starts power-on self-test (POST) processing (step S23).

Then, the platform 12-1 shifts to a POST processing completion standby state and determines whether a POST error has occurred. When no POST error has occurred, the platform 12-1 shifts to a system start-up state, terminates the POST processing, and notifies the power supply control microcomputer 24 of the system start-up state and the POST processing termination (step S24).

Then, the platform 12-1 starts up the OS (for example, Windows) (step S25) and loads a driver (step S26).

Moreover, the platform 12-1 starts up a predetermined service (step S27), and when the start-up of the service is completed, the platform 12-1 notifies the power supply control microcomputer 24 of the service start-up completion (step S28).

On the other hand, the power supply control microcomputer 24, which has detected that the platform 12-1 has shifted to the system start-up state by the notification of step S24, checks the connection state of the platforms 12-2 to 12-7 (denoted as sub-boards in the drawing) (step S29), and performs power-on control of each of the platforms 12-2 to 12-7 (step S30). Specifically, only a connection port is powered on.

Subsequently, the power supply control microcomputer 24 confirms whether fans of the platforms 12-2 to 12-7 are operating normally (step S31) and instructs the platforms 12-2 to 12-7, of which the fans are operating normally, to start to operate (step S32).

In this way, the platforms 12-2 to 12-7 starts up the OS (for example, Linux) (step S33) and loads drivers (step S34).

Moreover, when the start-up is completed, the platforms 12-2 to 12-7 notify the power supply control microcomputer 24 of the start-up completion (step S35).

As a consequence, when the power supply control microcomputer 24 confirms that the system start-up has been completed by the start-up of the platform 12-1 and the platforms 12-2 to 12-7 (step S36), the power supply control microcomputer 24 shifts the power LED to a lighting state (step S37).

As a consequence, the power supply unit 21, the power supply control microcomputer 24, the platform 12-1, the PCIe bridge controller 23, and the platforms 12-2 to 12-7 shift to a normal working state (S0 state).

As described above, according to the present first embodiment, the power supply control microcomputer 24 can start the driving of the PCIe bridge controller 23 before the start-up of the platforms 12-1 to 12-7, and then can start up the platforms 12-1 to 12-7.

Next, processing at the time of shutdown will be described.

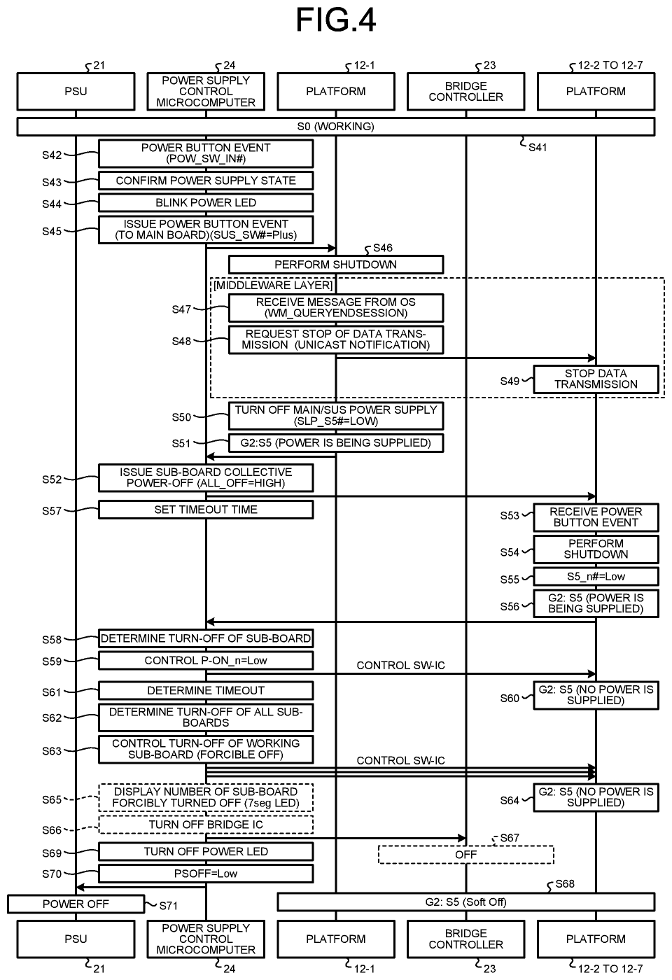

FIG. 4 is a diagram for explaining an example of a processing sequence flowchart at the time of shutdown processing of the first embodiment.

In an initial state, it is assumed that the power supply unit 21, the power supply control microcomputer 24, the platform 12-1, the PCIe bridge controller 23, and the platforms 12-2 to 12-7 are in a working state (SO state) (step S41).

When the power switch 26 is continuously pressed for a predetermined period of time (for example, 1 second) or more in a lighting state of a power lamp (not illustrated) or when hardware abnormality is detected, the power supply control microcomputer 24 executes a power button event (step S42) and confirms a power supply state (step S43).

Subsequently, the power supply control microcomputer 24 shifts the power LED to a flickering state (step S44).

Next, the power supply control microcomputer 24 issues a power button event for performing shutdown to the platform 12-1 (step S45).

In this way, the platform 12-1 performs shutdown control (step S46).

At this time, a message about the shutdown is transmitted from the OS to middleware, and when the message is received (step S47), the middleware individually transmits a data transmission stop request to the platforms 12-2 to 12-7 by unicast notification (step S48).

As a consequence, the platforms 12-2 to 12-7 having received the data transmission stop request stop data transmission (step S49).

On the other hand, the platform 12-1 instructs the power supply control microcomputer 24 to turn off a main power supply and a suspend power supply (SUS) (step S50). Specifically, the platform 12-1 gives an instruction by setting a signal SLP_S5# illustrated in FIG. 1 to a “L” level.

In this way, the platform 12-1 enters shutdown state in which the power has been supplied from the power supply unit (step S51).

When the platform 12-1 enters the shutdown state, the power supply control microcomputer 24 issues a command (collective power-off command) for collectively turning off the power of the platforms 12-2 to 12-7 (step S52), and sets a timeout time (step S57).

On the other hand, when the collective power-off command as a power button event is received (step S53), the platforms 12-2 to 12-7, which are operating normally, perform the shutdown (step S54).

Then, the platforms 12-2 to 12-7 set corresponding signal lines S5_2# to S5_7# to a “L” level and notifies the power supply control microcomputer 24 of the setting of the signal lines S5_2# to S5_7# (step S55).

Then, the platforms 12-2 to 12-7 enter the shutdown state in which the power has been supplied from the power supply unit 21 (step S56).

On the other hand, the power supply control microcomputer 24 refers to the signal lines S5_2# to S5_7# and determines whether each of the platforms 12-2 to 12-7 has been turned off by performing the shutdown (step S58).

Specifically, the power supply control microcomputer 24 determines whether each of the signal lines S5_2# to S5_7# is at the “L” level.

Next, when the signal line S5_n# (n is a natural number of 2 to 7) is at the “L” level, the power supply control microcomputer 24 performs control to set a corresponding signal line P-ON_n to a “L” level (step S59).

As a consequence, since control is performed such that the switching IC 25-n corresponding to the signal line P-ON_n is turned off, the platform 12-n corresponding to the turned-off switching IC 25-n enters the shutdown state in which power from the power supply unit 21 is shut off (step S60).

Subsequently, the power supply control microcomputer 24 determines whether the timeout time set in step S has elapsed (step S61).

When it is determined at step S61 that the timeout time set in step S57 has not elapsed (No at step S61), the power supply control microcomputer 24 determines whether all the platforms 12-2 to 12-7 have been turned off (step S62).

When it is determined at step S62 that all the platforms 12-2 to 12-7 have been turned off (Yes at step S62), the power supply control microcomputer 24 proceeds the process to step S66.

When it is determined at step S62 that all the platforms 12-2 to 12-7 have not been turned off (No at step S62), the power supply control microcomputer 24 waits for a certain period of time and proceeds the process to step S58.

When it is determined at step S61 that the timeout time set in step S has elapsed (Yes at step S61), the power supply control microcomputer 24 determines whether all the platforms 12-2 to 12-7 have been turned off (step S62).

When it is determined at step S62 that all the platforms 12-2 to 12-7 have been turned off (Yes at step S62), the power supply control microcomputer 24 proceeds the process to step S66.

When it is determined at step S62 that all the platforms 12-2 to 12-7 have not been turned off (No at step S62), the power supply control microcomputer 24 forcibly turns off a switching IC 25-x corresponding to a working platform (step S63). In this way, all the platforms 12-2 to 12-7 enters the shutdown state in which power is shut off (step S64).

Then, the power supply control microcomputer 24 displays the number of the platform forcibly turned off (step S65).

Subsequently, the power supply control microcomputer 24 shuts off the power to the PCIe bridge controller 23, so that the PCIe bridge controller 23 is turned off (step S66).

In such a state, the platforms 12-1 to 12-7 and the PCIe bridge controller 23 enter the shutdown state (soft-off state) (step S68).

On the other hand, the power supply control microcomputer 24 turns off the power LED that is turned on when power is supplied (step S69), and sets a signal line PSOFF to a “L” level (step S70).

As a consequence, the power supply unit 21, which has detected that the signal line PSOFF has been set to the “L” level, stops output (step S71).

As described above, according to the first embodiment, when the power button is pressed in a predetermined form (for example, long press), the power supply control microcomputer 24 recognizes it as a shutdown instruction, and serves as a power supply controller to detect the shutdown of all the information processing devices and then performs control to shut off the supply of power to the PCIe bridge controller 23 serving as the relay device and the platforms 12-1 to 12-7 serving as the information processing devices. Therefore, even though a platform serving as a host (a root complex serving as a host) is in an inoperable state or in a state in which communication is not possible in a software manner, it is possible to reliably perform the shutdown processing.

### [2] Second Embodiment

The aforementioned first embodiment corresponds to a case of shifting to the shutdown processing in response to an operation of the power button. However, in the present second embodiment, the shutdown processing is selected on an application of the platform 12-1 serving as a host (a root complex serving as a host).

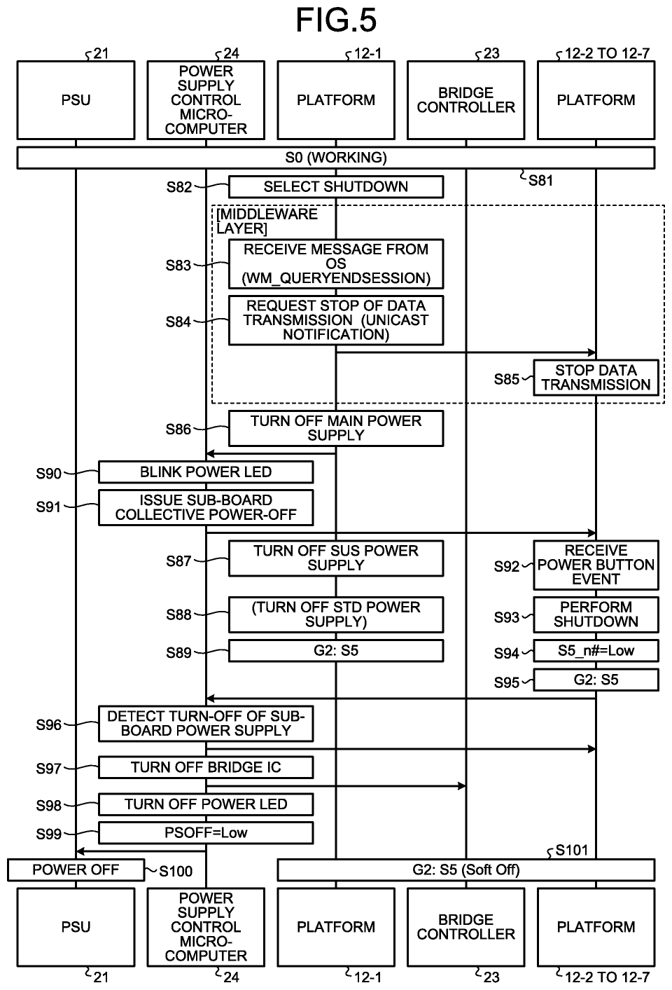

FIG. 5 is a diagram for explaining an example of a processing sequence flowchart at the time of shutdown processing of the second embodiment.

In an initial state, it is assumed that the power supply unit 21, the power supply control microcomputer 24, the platform 12-1, the PCIe bridge controller 23, and the platforms 12-2 to 12-7 are in a working state (S0 state) (step S81).

When a shutdown is selected on an application 30-1 of the platform 12-1 (step S82), a message about the shutdown is transmitted from an OS 33-1, and when the message is received (step S83), the middleware individually transmits a data transmission stop request to the platforms 12-2 to 12-7 by unicast notification (step S84).

As a consequence, the platforms 12-2 to 12-7 having received the data transmission stop request stop data transmission (step S85).

Furthermore, the platform 12-1 turns off the main power supply and notifies the power supply control microcomputer 24 of the turn-off of the main power supply (step S86).

Then, the platform 12-1 turns off the suspend (SUS) power supply (step S87), turns off a standby (STD) power supply (step S88), and enters the shutdown state (step S89).

On the other hand, when the notification indicating the turn-off of the main power supply is received from the platform 12-1, the power supply control microcomputer 24 shifts the power LED to a flickering state (step S90).

Then, the power supply control microcomputer 24 issues a command (collective power-off command) for collectively turning off the power of the platforms 12-2 to 12-7 (step S91).

In this way, when the collective power-off command as a power button event is received (step S92), the platforms 12-2 to 12-7, which are operating normally, perform the shutdown (step S93).

Then, the platforms 12-2 to 12-7 set the corresponding signal lines S5_2# to S5_7# to a “L” level and notifies the power supply control microcomputer 24 of the setting of the signal lines S5_2# to S5_7# (step S94).

Then, the platforms 12-2 to 12-7 are shut down (step S95).

On the other hand, the power supply control microcomputer 24 refers to the signal lines S5_2# to S5_7# and determines whether each of the platforms 12-2 to 12-7 has been turned off by performing the shutdown (step S96).

Specifically, the power supply control microcomputer 24 determines whether all the signal lines S5_2# to S5_7# are at the “L” level.

When it is determined at step S96 that all the signal lines S5_2# to S5_7# are at the “L” level, the power supply control microcomputer 24 shuts off the power to the PCIe bridge controller 23, so that the PCIe bridge controller 23 is turned off (step S97).

In such a state, the platforms 12-1 to 12-7 and the PCIe bridge controller 23 enter the shutdown state (soft-off state) (step S101).

On the other hand, the power supply control microcomputer 24 turns off the power LED that is turned on when power is supplied (step S98), and sets the signal line PSOFF to a “L” level (step S99).

As a consequence, the power supply unit 21, which has detected that the signal line PSOFF has been set to the “L” level, stops output (step S100).

As described above, according to the second embodiment, when the shutdown is selected in the platform 12-1 serving as a host, the power supply control microcomputer 24 serves as the power supply controller to detect the shutdown of all the information processing devices and then performs control to shut off the supply of power to the relay device and the information processing devices. Therefore, even though a platform serving as a device is in an inoperable state or in a state in which communication is not possible in a software manner, it is possible to reliably perform the shutdown processing.

### [3] Third Embodiment

The aforementioned second embodiment is an embodiment of the case where the shutdown processing is selected on the application of the platform 12-1 serving as a host. The present third embodiment is an embodiment of a case where the shutdown is selected on an operation management menu commonly managed in the platform 12-1 to the platform 12-7.

In the following description, a case where the platforms 12-1 to 12-7 perform artificial intelligence (AI) processing in cooperation will be described as an example.

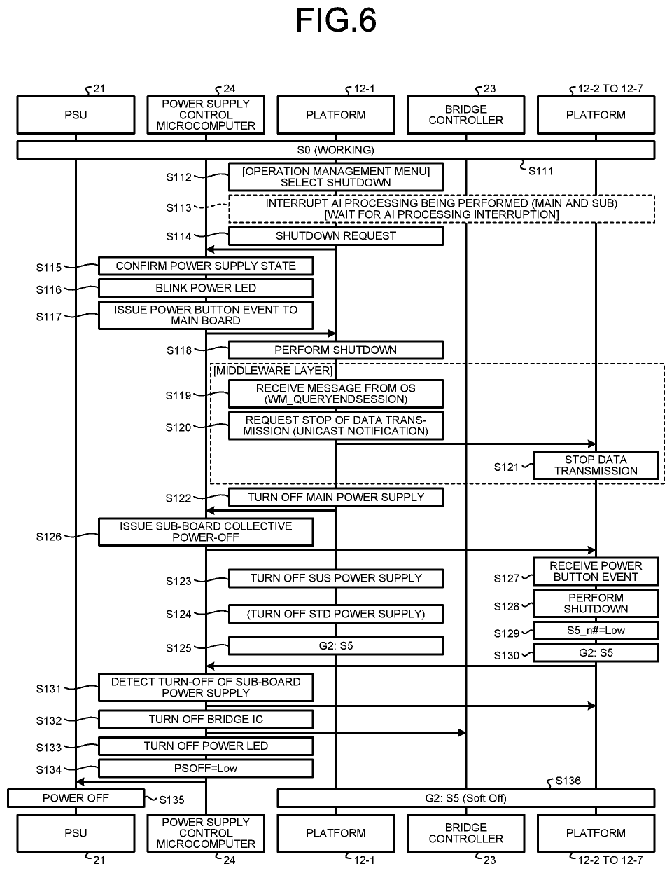

FIG. 6 is a diagram for explaining an example of a processing sequence flowchart at the time of shutdown processing of the third embodiment.

In an initial state, it is assumed that the power supply unit 21, the power supply control microcomputer 24, the platform 12-1, the PCIe bridge controller 23, and the platforms 12-2 to 12-7 are in a working state (SO state) (step S111).

When a shutdown is selected on the operation management menu commonly managed in the platform 12-1 to the platform 12-7 (step S112), the platform 12-1 to the platform 12-7 interrupts the processing being performed, that is, the AI processing performed in cooperation (step S113).

Then, the platform 12-1 serving as a host (or a root complex having a host function) transmits a shutdown request to the power supply control microcomputer 24 (step S114).

In this way, the power supply control microcomputer 24 confirms a power supply state (step S115) and shifts the power LED to a flickering state (step S116).

Next, the power supply control microcomputer 24 issues a power button event for performing the shutdown to the platform 12-1 (step S117).

In this way, the platform 12-1 performs shutdown control (step S118).

At this time, a message about the shutdown is transmitted from the OS to middleware, and when the message is received (step S119), the middleware individually transmits a data transmission stop request to the platforms 12-2 to 12-7 by unicast notification (step S120).

As a consequence, the platforms 12-2 to 12-7 having received the data transmission stop request stop data transmission (step S121).

Furthermore, the platform 12-1 turns off the main power supply and notifies the power supply control microcomputer 24 of the turn-off of the main power supply (step S122).

Then, the platform 12-1 turns off the suspend power supply (SUS) (step S123), turns off the standby power supply (STD) (step S124), and enters the shutdown state (step S125).

On the other hand, when the notification indicating the turn-off of the main power supply is received from the platform 12-1, the power supply control microcomputer 24 issues a command (collective power-off command) for collectively turning off the power of the platforms 12-2 to 12-7 (step S126).

In this way, when the collective power-off command as a power button event is received (step S127), the platforms 12-2 to 12-7, which are operating normally, perform the shutdown (step S128).

Then, the platforms 12-2 to 12-7 set the corresponding signal lines S5_2# to S5_7# to a “L” level and notifies the power supply control microcomputer 24 of the setting of the signal lines S5_2# to S5_7# (step S129).

Then, the platforms 12-2 to 12-7 are shut down (step S130).

On the other hand, the power supply control microcomputer 24 refers to the signal lines S5_2# to S5_7# and determines whether each of the platforms 12-2 to 12-7 has been turned off by performing the shutdown (step S131).

Specifically, the power supply control microcomputer 24 determines whether all the signal lines S5_2# to S5_7# are at the “L” level.

When it is determined at step S131 that all the signal lines S5_2# to S5_7# are at the “L” level, the power supply control microcomputer 24 shuts off the power to the PCIe bridge controller 23, so that the PCIe bridge controller 23 is turned off (step S132).

In such a state, the platforms 12-1 to 12-7 and the PCIe bridge controller 23 enter the shutdown state (soft-off state) (step S136).

On the other hand, the power supply control microcomputer 24 turns off the power LED that is turned on when power is supplied (step S133), and sets the signal line PSOFF to a “L” level (step S134).

As a consequence, the power supply unit 21, which has detected that the signal line PSOFF has been set to the “L” level, stops output (step S135).

As described above, according to the third embodiment, when the shutdown is selected on the operation management menu commonly managed in the platform 12-1 to the platform 12-7 that perform processing in cooperation, since the platform 12-1 serving as a root complex performs a trigger operation for a shutdown operation and the power supply control microcomputer 24 serves as the power supply controller to detect the shutdown of all the information processing devices and then performs control to shut off the supply of power to the PCIe bridge controller 23 as the relay device and the platforms 12-1 to 12-7 as the information processing devices, it is possible to reliably perform the shutdown processing.

### [4] Fourth Embodiment

In the aforementioned third embodiment, the platform 12-1 serving as a root complex transmits the shutdown request to the power supply control microcomputer 24 and all the platforms 12-1 to 12-7 shift to the shutdown processing under the control of the power supply control microcomputer 24. However, the present fourth embodiment is an embodiment of a case where the platform 12-1 serving as a root complex leads the shutdown processing.

In the following description, similarly to the third embodiment, a case where the platforms 12-1 to 12-7 perform the AI processing in cooperation will be described as an example.

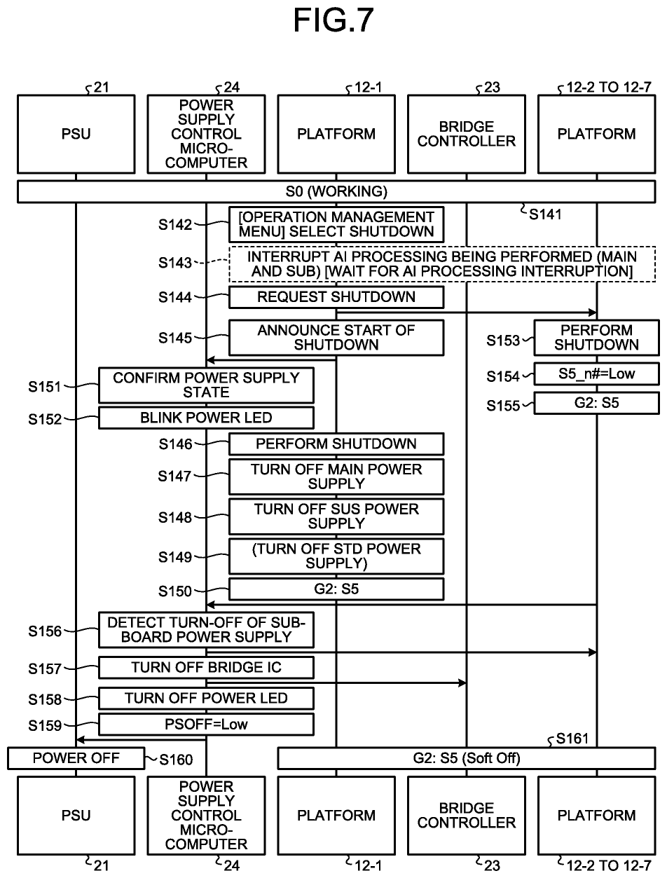

FIG. 7 is a diagram for explaining an example of a processing sequence flowchart at the time of shutdown processing of the fourth embodiment.

In an initial state, it is assumed that the power supply unit 21, the power supply control microcomputer 24, the platform 12-1, the PCIe bridge controller 23, and the platforms 12-2 to 12-7 are in a working state (S0 state) (step S141).

When a shutdown is selected on the operation management menu commonly managed in the platform 12-1 to the platform 12-7 (step S142), the platform 12-1 to the platform 12-7 interrupts the processing being performed, that is, the AI processing performed in cooperation (step S143).

Then, the platform 12-1 serving as a root complex transmits a shutdown request to the platforms 12-2 to 12-7 (step S144).

In this way, the platforms 12-2 to 12-7, which receive the shutdown request and are operating normally, perform the shutdown (step S153).

Then, the platforms 12-2 to 12-7 set the corresponding signal lines S5_2# to S5_7# to a “L” level and notifies the power supply control microcomputer 24 of the setting of the signal lines S5_2# to S5_7# (step S154).

Then, the platforms 12-2 to 12-7 are shut down (step S155).

On the other hand, the platform 12-1 notifies the power supply control microcomputer 24 of the start of the shutdown (step S145).

Then, the platform 12-1 performs shutdown control (step S146), turns off the main power supply (step S147), turns off the suspend power supply (SUS) (step S148), and turns off the standby power supply (STD) (step S149).

As a consequence, the platform 12-1 enters the shutdown state (step S150).

On the other hand, the power supply control microcomputer 24 refers to the signal lines S5_2# to S5_7# and determines whether each of the platforms 12-2 to 12-7 has been turned off by performing the shutdown (step S156).

Specifically, the power supply control microcomputer 24 determines whether all the signal lines S5_2# to S5_7# are at the “L” level.

When it is determined at step S156 that all the signal lines S5_2# to S5_7# are at the “L” level, the power supply control microcomputer 24 shuts off the power to the PCIe bridge controller 23, so that the PCIe bridge controller 23 is turned off (step S157).

In such a state, the platforms 12-1 to 12-7 and the PCIe bridge controller 23 enter the shutdown state (soft-off state) (step S161).

On the other hand, the power supply control microcomputer 24 turns off the power LED that is turned on when power is supplied (step S158), and sets the signal line PSOFF to a “L” level (step S159).

As a consequence, the power supply unit 21, which has detected that the signal line PSOFF has been set to the “L” level, stops output (step S160).

As described above, according to the fourth embodiment, when the shutdown is selected on the operation management menu commonly managed in the platform 12-1 to the platform 12-7 that perform processing in cooperation, the platform 12-1 serving as a root complex leads the shutdown operation and the power supply control microcomputer 24 serves as the power supply controller to detect the shutdown of the platforms 12-1 to 12-7 and then performs control to shut off the supply of power to the PCIe bridge controller 23 as the relay device and the platforms 12-1 to 12-7 as the information processing devices. Therefore, it is possible to reliably perform the shutdown processing.

### [5] Others

The disclosed technology is not limited to the aforementioned embodiment and various modifications can be made without departing from the scope of the present embodiment. Each configuration and each processing of the present embodiment can be selected as needed or may be appropriately combined.

For example, in the configuration illustrated in FIG. 1, the seven platforms 12-1 to 12-7 can be connected to the PCIe bridge controller 23; however, the present invention is not limited thereto and the PCIe bridge controller 23 may also include six or less or eight or more platforms.

Furthermore, in the aforementioned embodiment, the PCIe (PCI express) has been described as an example of an I/O interface of each element; however, the I/O interface is not limited to the PCIe.

For example, it is sufficient if the I/O interface of each element is a technology capable of transmitting data between a device (peripheral controller) and a processor by a data transfer bus.

Furthermore, the data transfer bus may also be a general-purpose bus capable of transmitting data at a high speed in a local environment (for example, one system or one device) provided in one housing and the like.

Furthermore, the I/O interface may be either a parallel interface or a serial interface.

Furthermore, it is sufficient if the I/O interface can perform a point-to-point connection and has a configuration that can serially transfer data on a packet base.

Furthermore, the I/O interface may also have a plurality of lanes in the case of the serial transfer.

Furthermore, a layer structure of the I/O interface may also have a transaction layer that generates and decodes a packet, a data link layer that performs error detection and the like, and a physical layer that performs serial-parallel conversion.

Furthermore, the I/O interface may also include a root complex having one or a plurality of ports at the top of the hierarchy, an endpoint that is an I/O device, a switch for increasing ports, a bridge that converts a protocol, and the like.

Furthermore, the I/O interface may also multiplex data to be transmitted and a clock signal by a multiplexer and transmit the multiplexed signal. In such a case, it is sufficient if a reception side separates the data and the clock signal by a demultiplexer.

Furthermore, according to the aforementioned disclosure, the present embodiment can be embodied and manufactured by a person skilled in the art.

### [6] Further Aspects of Embodiment

Regarding the above embodiment, further aspects will be further described.

[6. 1] First Further Aspect

An information processing system of a first further aspect of the embodiment is an information processing system including a plurality of information processing devices each including a processor and a relay device that is able to connect the plurality of information processing devices via an expansion bus and relays communication between the plurality of information processing devices, in which the relay device includes a power supply controller that controls the supply of power to the plurality of information processing devices, and performs control to shut off the supply of the power to the relay device and the plurality of information processing devices after detecting shutdown of all the plurality of information processing devices.

According to the aforementioned configuration, the power supply controller detects the shutdown of all the plurality of information processing devices and then performs control to shut off the supply of the power to the relay device and the plurality of information processing devices. Therefore, even though an information processing device serving as a root complex is in an inoperable state or in a state in which communication is not possible in a software manner, it is possible to reliably perform the shutdown processing.

[6. 2] Second Further Aspect

An information processing system of a second further aspect of the embodiment is the information processing system in the first further aspect, in which the power supply controller performs control to shut off the supply of the power to the plurality of information processing devices and then performs control to shut off the supply of the power to the relay device.

According to the aforementioned configuration, in the shutdown processing, it is possible to reliably shut off the supply of the power to the relay device.

[6. 3] Third Further Aspect

An information processing system of a third further aspect of the embodiment is the information processing system in the first further aspect, in which the relay device includes a power button for performing power supply and shutdown instruction operations and in response to power shutdown being instructed by the power button, the power supply controller sequentially transmits shutdown instructions to the plurality of information processing devices.

According to the aforementioned configuration, when the power button is pressed in a predetermined form (for example, long press), the power supply controller recognizes it as a shutdown instruction and performs control to shut off the supply of the power to the relay device and the plurality of information processing devices. Therefore, even though an information processing device serving as a host is in an inoperable state or in a state in which communication is not possible in a software manner, it is possible to reliably perform the shutdown processing by operating the power button.

[6. 4] Fourth Further Aspect

An information processing system of a fourth further aspect of the embodiment is the information processing system in the third further aspect, in which the plurality of information processing devices include a first information processing device serving as a host and a second information processing device serving as a device, and the power supply controller transmits a shutdown instruction to the first information processing device and in response to detecting a shutdown of the first information processing device, transmits a shutdown instruction to the second information processing device.

According to the aforementioned configuration, when the first information processing device serving as a host is operating normally, it is possible to reliably perform the shutdown processing by the first information processing device.

[6. 5] Fifth Further Aspect

An information processing system of a fifth further aspect of the embodiment is the information processing system in the first or second further aspect, in which the plurality of information processing devices include a first information processing device serving as a host and second information processing devices serving as devices, and in response to detecting that a main power supply in the first information processing device is shut down in shutdown processing in the first information processing device, the power supply controller sequentially transmits shutdown instructions to the second information processing devices.

At the stage when it is detected that the main power supply of the first information processing device is shut down in the shutdown of the first information processing device, it is possible to reliably shut down the entire information processing system regardless of the states of the second information processing devices.

[6. 6] Sixth Further Aspect

An information processing system of a sixth further aspect of the embodiment is the information processing system in the first or second further aspect, in which the plurality of information processing devices include a first information processing device serving as a host and a second information processing device serving as a device, and the power supply controller transmits a shutdown instruction to the first information processing device in response to receiving a shutdown request from the first information processing device and transmits a shutdown instruction to the second information processing device in response to detecting shutdown of the first information processing device.

According to the aforementioned configuration, only by the first information processing device transmitting the shutdown request, it is possible to reliably shut down the entire information processing system regardless of the states of the second information processing devices.

[6. 7] Seventh Further Aspect

An information processing system of a seventh further aspect of the embodiment is the information processing system in the first further aspect, in which the plurality of information processing devices include a first information processing device serving as a host and second information processing devices serving as devices, and in response to receiving a shutdown start notification for performing shutdown of the first information processing device and the second information processing devices from the first information processing device, and detecting shutdown of all the second information processing devices, the power supply controller performs control to shut off supply of power to the relay device prior to control to shut off the supply of the power to the plurality of information processing devices.

According to the aforementioned configuration, it is possible to reliably shut down the relay device, too, when the information processing system is shut down.

[6. 8] Eighth Further Aspect

A relay device of an eighth further aspect of the embodiment is a relay device that can connect a plurality of information processing devices via an expansion bus and relays communication between the information processing devices, in which the relay device includes: a bridge controller that controls the relay of the communication between the plurality of information processing devices; and a power supply controller that controls supply of power to the bridge controller prior to control to supply power to the plurality of information processing devices, and performs control to shut off the supply of the power to the relay device and the plurality of information processing devices after detecting a shutdown of all the plurality of information processing devices.

According to the aforementioned configuration, by applying the relay device to the plurality of information processing devices, it is possible to perform the shutdown processing without being affected by the states of the plurality of information processing devices.

According to an aspect of the present disclosure, since the power supply controller detects the shutdown of all the information processing devices and then performs control to shut off the supply of the power to the relay device and the information processing devices, it is possible to reliably perform the shutdown processing even though for example, an information processing device serving as a root complex is in an inoperable state or in a state in which communication is not possible in a software manner.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. An information processing system comprising:
a plurality of information processing devices each including a processor; and
a relay device that connects the information processing devices via an expansion bus and relays communication between the information processing devices, wherein
the relay device comprises a power supply controller that controls supply of power to the information processing devices, and performs control to shut off supply of power to the relay device and the information processing devices after detecting shutdown of all the information processing devices.

2. The information processing system according to claim 1, wherein the power supply controller performs control to shut off supply of power to the information processing devices and then performs control to shut off supply of power to the relay device.

3. The information processing system according to claim 1, wherein
the relay device comprises a power button that is operated to receive a power supply instruction and a shutoff instruction, and
in response to power shutoff being instructed via the power button, the power supply controller sequentially transmits shutdown instructions to the information processing devices.

4. The information processing system according to claim 3, wherein
the information processing devices comprise:
a first information processing device serving as a host; and
a second information processing device serving as a device, and
the power supply controller transmits a shutdown instruction to the first information processing device and in response to detecting shutdown of the first information processing device, transmits a shutdown instruction to the second information processing device.

5. The information processing system according to claim 1, wherein
the information processing devices comprise:
a first information processing device serving as a host; and
second information processing devices serving as devices, and
in response to detecting that a main power supply in the first information processing device is shut off in shutdown processing in the first information processing device, the power supply controller sequentially transmits shutdown instructions to the second information processing devices.

6. The information processing system according to claim 1, wherein
the information processing devices comprise:
a first information processing device serving as a host; and
a second information processing device serving as a device, and
the power supply controller transmits a shutdown instruction to the first information processing device in response to receiving a shutdown request from the first information processing device, and transmits a shutdown instruction to the second information processing device in response to detecting shutdown of the first information processing device.

7. The information processing system according to claim 1, wherein
the information processing devices comprise:
a first information processing device serving as a host; and
second information processing devices serving as devices, and
in response to receiving a shutdown start notification for performing shutdown of the first information processing device and the second information processing devices from the first information processing device, and detecting shutdown of all the second information processing devices, the power supply controller performs control to shut off supply of power to the relay device prior to control to shut off supply of power to the information processing devices.

8. A relay device that connects a plurality of information processing devices via an expansion bus and relays communication between the information processing devices, the relay device comprising:
a bridge controller that controls relay of communication between the information processing devices; and
a power supply controller that controls supply of power to the bridge controller prior to control to supply power to the information processing devices, and performs control to shut off supply of power to the relay device and the information processing devices after detecting shutdown of all the information processing devices.
